(19) United States
(12) Patent Application Publication
(10) Pub. No.: US 2026/0359967 A1
(43) Pub. Date: Nov. 12, 2026

(54) GENERALIZED IMAGE QUALITY QUANTIFICATION

(71) Applicant: Seagate Technology LLC, Fremont, CA (US)

(72) Inventors: Khoi Khac Nguyen, Londonderry (GB); Carrie Wright, Bloomington, MN (US); Aaron Robert Mislivec, Saint Paul, MN (US); James E. Ness, Stacy, MN (US)

(21) Appl. No.: 19/202,672

(22) Filed: May 8, 2025

(51) Int. Cl. G06T 7/00; G06T 5/20; G06T 5/60; G06T 5/70; G06T 7/11; G06T 7/12; G06T 7/194; G06T 7/20

(52) U.S. Cl. CPC G06T 7/001; G06T 5/20; G06T 5/60; G06T 5/70; G06T 7/11; G06T 7/12; G06T 7/194; G06T 7/20; G06T 2207/10061; G06T 2207/20081; G06T 2207/30148; G06T 2207/30168

(57) ABSTRACT

Described are systems and methods for image quality quantification. Such systems and methods may involve segmenting an image into a plurality of patches. A set of qualified patches are then prepared, for example based on the presence of component edge features and/or other criteria. From the qualified patches, a quality score metric may be generated along with an estimate of significance of the patch to the quality of the overall image. The estimate of significance may be correlated to the number of component edge features present in a patch. Composite quality scores for the image may be determined by combining the quality score metrics for all patches in an importance-weighted fashion using the estimate of significance. Also described are systems and methods for facilitating decisions regarding good and bad image quality, image acquisition processes and tools, and so forth.

### TECHNICAL FIELD

The disclosure relates to systems and methods for determining and quantifying image quality.

### SUMMARY

In some aspects, the techniques described herein relate to a method for evaluating the quality of an image, the method including: segmenting the image into a plurality of N patches; preparing a plurality of L qualified patches from at least a subset of the N patches; for each patch of the L qualified patches, generating a quality score metric and an estimate of significance to overall quality of the image; and combining the quality score metrics for all patches in an importance-weighted fashion using the estimate of significance to thereby generate one or more composite focus quality scores for the image. For example, the one or more composite focus quality scores may include an average blurriness score, a vertical blurriness score, and a horizontal blurriness score.

In some aspects, the method may further include eliminating background noise from the image prior to segmenting the image into the plurality of N patches.

In some aspects, the method may further include identifying whether a patch includes a connected component feature, for example by determining whether a number of pixels associated with the connected component feature exceeds a threshold pixel amount.

In some aspects, the method may include selecting M candidate patches from the N patches, each of the M candidate patches including at least one connected component feature. In some aspects, preparing the L qualified patches includes, for each of the connected component features included in a corresponding one of the M candidate patches, shifting the corresponding candidate patch to place the connected component feature at or near a center of the corresponding candidate patch, thereby creating a shifted candidate patch for each of the connected component features.

In some aspects, the method may include removing one or more of the shifted candidate patches that are determined to include connected component features duplicated in at least one other of the shifted candidate patches.

In some aspects, the method may further include, for each patch of the L qualified patches, identifying edges of any component features. Moreover, a corresponding mask may be created using the identified edges of any component features, and the corresponding mask may be applied to the patch prior to generate a region of interest for the overall image.

In some aspects, the estimate of significance to overall quality of the image correlates to an amount of edges such that the estimate of significance is greater for patches that include more edges and the estimate of significance is less for patches that include fewer edges.

In some aspects, the techniques described herein relate to a system for evaluating the quality of generated images of specimens, the method including: at least one imaging tool for acquiring images to be analyzed; a data storage module to store images acquired by the at least one imaging tool; and an image analysis module configured to perform the following for an image acquired by the at least one imaging tool: segment the image into a plurality of N patches; prepare a plurality of L qualified patches from at least a subset of the N patches; for each patch of the L qualified patches, generate a quality score metric and an estimate of significance to overall quality of the image; and combine the quality score metrics for all patches in an importance-weighted fashion using the estimate of significance to thereby generate one or more composite focus quality scores for the image.

In some aspects, the techniques described herein relate to a system, further including a display module configured to display visualizations of composite focus quality scores produced by the image analysis module for a plurality of images generated by the at least one imaging tool.

In some aspects, the techniques described herein relate to a system, wherein the visualizations of composite focus quality scores are configured to facilitate setting thresholds for defining good image quality and bad image quality. For example, the visualizations of composite focus quality scores may facilitate setting different thresholds of image quality for each imaging tool, setting different thresholds of image quality for different specimen types, setting specifications for a factory process, and/or determining whether a change has occurred with image acquisition processes.

In some aspects, the techniques described herein relate to a system, wherein the image analysis module is further configured to save the composite focus quality scores to a database configured for remote access.

In some aspects, the techniques described herein relate to a system, wherein the system is integrated into a wafer production facility.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a flow chart depicting steps that may be performed in accordance with aspects of the present disclosure.

FIG. 2 is a flow diagram of steps involved in patch generation and selection in accordance with aspects of the present disclosure.

FIG. 3 is a flow diagram of steps involved in patch evaluation in accordance with aspects of the present disclosure.

FIG. 4 schematically illustrates the calculation of image quality in accordance with aspects of the present disclosure.

FIG. 5 is a flow chart depicting steps that may be performed in evaluating image quality of a plurality of stored images in accordance with aspects of the present disclosure.

FIG. 6 is a flow chart illustrating aspects of the present disclosure as deployed in a production environment.

FIGS. 7A-F are charts depicting data that may be utilized in setting specifications and/or thresholds for use in determining quality of images in accordance with aspects of the present disclosure.

### DETAILED DESCRIPTION

The present disclosure relates to image quality quantification that is scalable across any general set of images, for example images of specimens acquired in a test environment, without reliance on extensive manual review or individually trained models for each image class or type. Accordingly, the present disclosure relates to scaling image focus quantification across any arbitrary series of images, for example images involved in wafer production during hard disk drive (HDD) manufacturing. Aspects of the present disclosure are generalizable to any image analysis that may otherwise rely on manual inspection, deep learning, or a combination of both. Rather than relying on extensive manual review or individually trained models for each process, the present disclosure uses an advanced algorithm capable of evaluating any image or field of view (FOV) and providing quality scoring. In particular, aspects of the present disclosure may be used to generate composite image quality values that include a blurry average score, a blurry vertical score, and a blurry horizontal score.

In accordance with various aspects, solutions of the present disclosure work by segmenting each image into smaller patches, with each patch being evaluated to produce two key metrics: a focus quality score and an estimate of significance to the overall image quality. These metrics are combined to calculate composite focus quality scores for the entire image, with each patch having a weighed contribution based on its importance to the overall image quality. Unlike previous approaches, this method does not require individual training for each imaging process or FOV, allowing it to be scaled across all stages. Moreover, the present disclosure makes use of an automated system that reviews historic data and generates necessary visualizations, significantly reducing manual effort and saving time and resources.

In wafer manufacturing, hundreds of millions of microscope images may be generated each year based on scanning electron microscope (SEM), focus ion beam (FIB), and electron-beam defect review (EDR) imaging of wafer specimens. Such images may be captured across hundreds of different processes, each with unique content and characteristics. These test processes are primarily used for inspection and metrology, providing valuable insights into process performance and defect detection. However, microscopes naturally drift out of focus over time due to factors including vibrations, calibration issues, and contamination. If this drift is not promptly detected, it can lead to incorrect measurements, increased scrap, wasted resources, tool downtime, and production delays. Thus, there is a need for a generalized model that can assess the quality of any acquired specimen image, ensuring accurate measurements and performance across a wide range of processes, while offering greater flexibility and scalability, and without requiring manual review or training of the model for each image type.

Current image evaluation approaches involve training deep convolutional neural networks for each process and FOV, using synthetic data to train and assess the focus quality. While effective, such approaches are limited by scale. With often tens if not hundreds of different image evaluation processes to manage, the time required for data processing and model development can be significant, particularly when each model must be specifically tailored to a particular stage and FOV, which can severely limit scalability. In various aspects, systems and methods of the present disclosure can be used to overcome such limitations on scalability due to their general applicability and lack of reliance on manual review or extensive model training.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

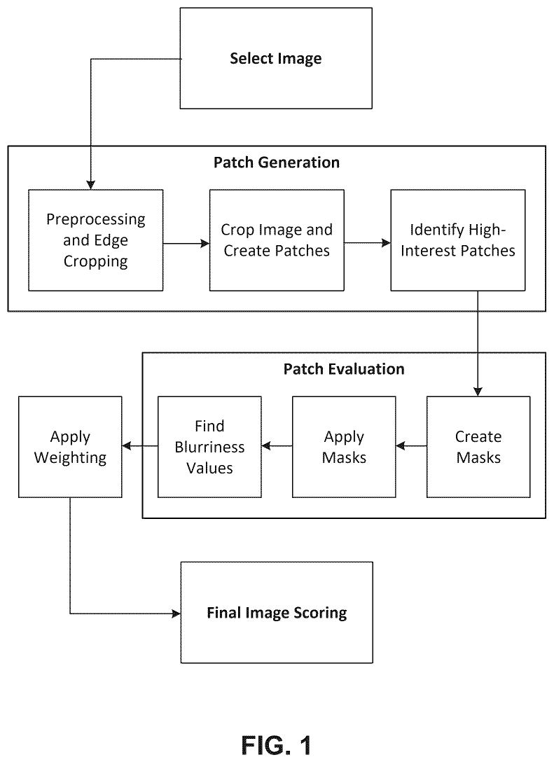

FIG. 1 shows a high-level flow chart of steps that may be performed in accordance with various aspects of the present disclosure to thereby assess image quality and to detect when images are out of focus. This methodology may be deployed across any images of any specimens acquired by any imaging system, microscope, or metrology process, and does not require manual data input or customized training of a machine learning algorithm. The general process can be divided into preprocessing, patch generation, patch evaluation, and final scoring.

In the initial preprocessing stage, an image is selected. Optionally, techniques such as Gaussian blurring and morphology may be used to eliminate background noise. For images that may include writing or other unwanted features or artifacts around the border, one or more of the edges may be cropped, for example by a set number of pixels from the top, bottom, left side, and/or right side. Such preprocessing and edge cropping produces a “clean” image for proceeding with the methodology for scoring blurriness.

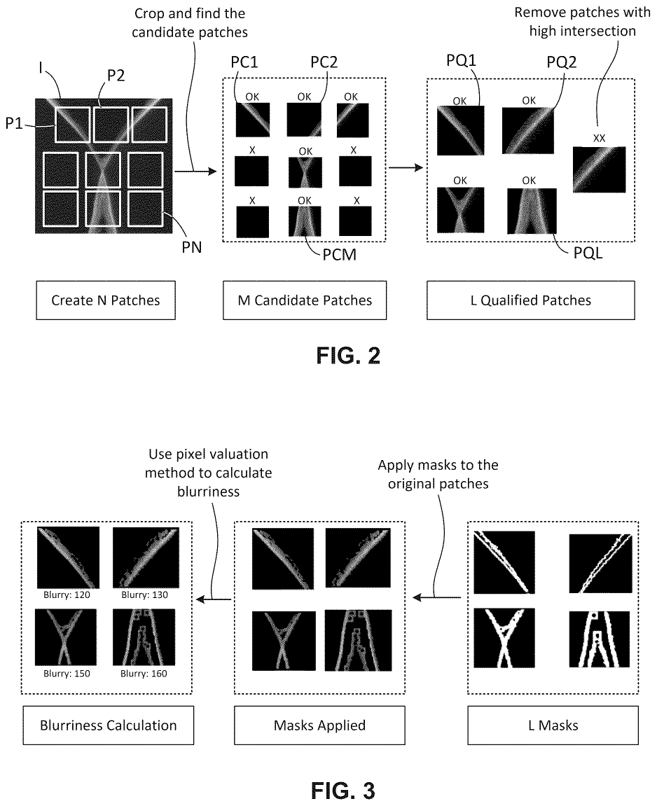

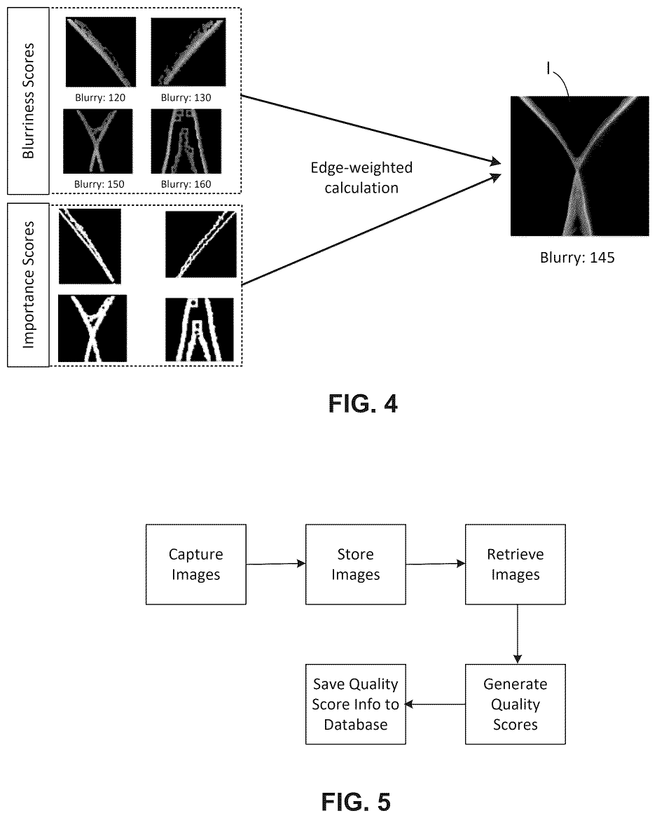

The next series of steps may be considered as patch generation. In patch generation (discussed in more detail in connection with FIG. 2), the image is divided into a number of patches. The patches are quantified based on one or more acceptability criteria to thereby identify and select the high-interest patches, also referred to as qualified patches. The next series of steps relate to patch evaluation. In patch evaluation, the individual qualified patches are evaluated by creating and applying masks that identify edges in the qualified patches (discussed in more detail in connection with FIG. 3). Next, two key metrics are produced for each patch, namely a focus quality score and an importance estimate, which weights each patch by its relative importance to the overall image. Final image quality scores are then produced by combining the focus quality scores of the patches weighted by the importance scores of the patches (discussed in more detail in connection with FIG. 4).

Certain aspects of the patch generation process are indicated in FIG. 2. This process involves cropping, shifting, and filtering. First the image I is divided into N different patches P1, P2, . . . , PN, for example arranged from left to right and from top to bottom. The N patches are cropped to create N separate patch images that are evaluated to find acceptable candidate patches. To quantify the acceptability of the patches, the patch images are binarized to identify features of connected components within each patch. Patches having at least one connected component larger than a set number of pixels, for example at least 50 pixels, are deemed acceptable as candidate patches (marked OK in FIG. 2). Patches not meeting this criterion are discarded (marked X in FIG. 2), leaving M candidate patches, PC1, PC2, . . . , PCM, where M is less than or equal to N.

To make a better visualization and to obtain more information, the M candidate patches may be shifted to new coordinates so that the features are more centered within each patch image. For example, when a patch includes a connected component feature, that connected component feature is placed near the center of the patch. Depending on the features present in a patch, multiple different features can be set as the patch center, resulting in multiple new patches being created from a single candidate patch. Shifting to create patches can lead to multiple patches overlapping, and therefore having a high degree of intersection and duplicative features. As such, thresholds can be set to flag high intersection and duplicative feature patches so that only a single patch is kept that includes a given component feature, with the other duplicative patches being removed. For example, patch XX in FIG. 2 may be removed due to high intersection and duplicative features relative to patch PQ2, which is retained. This preparation process results in L qualified patches, PQ1, PQ2, . . . , PQL, that may be used for individual patch evaluation, scoring, and final assessment.

FIG. 3 illustrates steps involved in individual patch preparation and evaluation, which involves evaluating and scoring each of the L qualified patches that remain after patch creation and selection. The image may be binarized, for example using thresholding and the Otsu method, to facilitate evaluation of the L qualified patches. The coordinates of the L qualified patches are used to create a corresponding set of L masks from the binarized images. These masks may be generated using a Laplacian edge detection method to identify the edges of the component features in each of the qualified patch images. Components having edges detected and defined in this process may be considered to be regions of interest (ROI) in the overall image.

Each mask is then applied to the original patch to which it corresponds to thereby extract useful information for scoring the blurriness in each patch. In accordance with aspects of the present disclosure, the pixel values may be correlated to blurriness in the images in the following manner. The maximum, minimum, and mean pixel values of each mask-applied patch, as well as the mean pixel value of the image, are used to construct a correlation matrix. A higher maximum pixel value in a mask-applied patch indicates that the patch is more in focus, while a lower value suggests that the patch is out of focus. This methodology is also applied to the other pixel values (that is, the minimum and the mean pixel values of the mask-applied patch and the mean pixel value of the image). All four different pixel values are combined (added) to obtain an individual blurry score for each patch. The blurry score can be shifted by set amounts and/or normalized to fit any arbitrary scale. The end result is L different blurry scores, each correlated to one of the L different qualified patches, which are now prepared for a final assessment.

FIG. 4 illustrates final image scoring. The final, composite quality scores for the overall image I utilizes an edge-weighted scheme in which L blurriness values obtained from the individual patch evaluation are combined in a weighted fashion based on the significance of each patch to the overall image I. In particular, patches with more edges are considered more important than patches with fewer edges. The individual patch blurry score is thereby multiplied by the number of edges in that patch to obtain a weighted amount. The weighted amounts for all the patches are added together, and the total sum is divided by the total number of edges in all the patches to reach a final blurry score for the overall image I. Lower scores represent images that are more in focus or of higher quality, while higher scores indicate images of poor quality or those that are out of focus. In FIG. 4, the blurry score for image I is 145 on a scale that ranges from 0 to 300.

FIG. 4 illustrates an example where final image scoring is generated based on a blurry average value for the whole image. It will be appreciated that the same procedure may also be employed to generate image scoring based on vertical blurry values (particularly useful for images having more prominent presence of vertical edges) and/or based on horizontal blurry values (particularly useful for images having more prominent presence of horizontal edges). As such, the present disclosure contemplates generating multiple composite focus quality scores for a given image.

Evaluating and scoring image quality in accordance with the above-described methodology may be used on images of specimens as they are captured, on a recently captured plurality of images, and/or on archived (historic) or saved images, to thereby evaluate current processes as well as to compare to prior imaging and metrology work. FIG. 5 represents a workflow for scoring images generated from a factory, for example. Any historical data can be used for evaluation purposes, analytics and other composite artificial intelligence (AI) or machine learning applications. Images captured from tools during metrology are generated and saved into an image server. Original images are retrieved without any preprocessing, and then are run through an image quality scoring process as described above. In certain aspects, up to three values of image quality may be generated for each image. All information is then saved into a database, such as a PostgreSQL table, for future use.

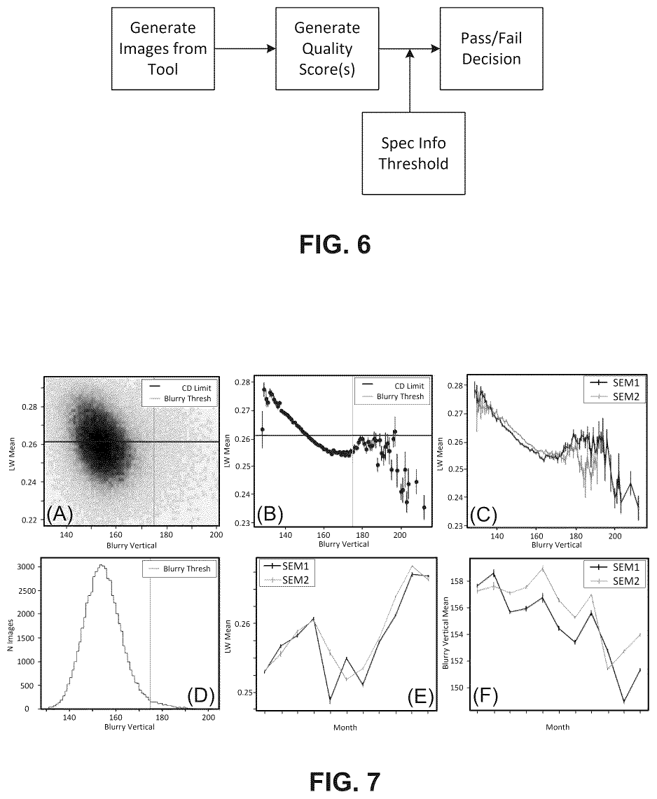

Moreover, historical data may be used to analyze correlation between critical dimension (CD) values of interest and image quality scores to help operators (engineers, metrologists, and so forth) in setting the specifications for factory and test processes. Such data can be useful for tool health monitoring, process monitoring, and other decision-making applications. FIG. 6 illustrates a system perspective for production deployment, for example in wafer fabrication. After performing metrology on a wafer specimen, quality scores may be generated for each generated image using a methodology in accordance with aspects of the present disclosure. To aid in determining a good/bad quality decision for each image, certain specification information or threshold value(s) set by engineers may be used for reference. For example, using an image quality score that ranges from 0-300, engineers may observe for a particular process that a score of 180 is a useful delineation between good images and bad image, and so a specification may be set at 180 for that process.

FIGS. 7A-F show different visualizations of historical data, for example gathered during shadow deployment, that may assist in setting specifications or thresholds for deciding the good/bad quality of images in production deployment of image quality quantification in accordance with the present disclosure. When engineers perform metrology, there may be two outputs from the tool: an image and a CD (a critical dimension represented by a floating number). As recognized by the present disclosure, there is significant correlation between the image quality at the edge of features of interest and the CD value. Accordingly, certain visualizations may be employed to help engineers make more accurate and quicker decisions on thresholds. The analytic-powered framework demonstrated by FIGS. 7A-F may be used to prevent human mistakes when setting a threshold for each stage, step, and FOV.

The six visualizations shown in FIG. 7 are as follows: (A) a distribution map, with each pixelated dot representing one data point; (B) a correlation with the average value of metrology data grouped by each generic blurry score; (C) a correlation separated by tool; (D) a number of metrology images grouped by blurry score; (E) an average of metrology data acquired in each month, separated by tool; and (F) an average blurry score in each month, separated by tool. Collecting such historical data and saving it in a table or database allows for easy access and analyzing to thereby decide the threshold for each stage, step, FOV, and machine. It can also be useful in determining whether and when certain process conditions have changed, whether there has been drift or abnormal behavior in a tool when producing images, and so forth. Engineers may be guided through a series of questions for each chart in the visualization to help define success parameters.

In FIG. 7, LW is the critical dimension measurement and LW Mean is the mean value for a given image. Blurry Vertical is one of the outputs generated by performing the method summarized in FIG. 1. For each image, three outputs may be generated: Blurry Average (from all patches), Blurry Vertical (from patches that are defined as “vertical,” meaning the patches have more vertical edges than horizontal edges), and Blurry Horizontal (from patches having more horizontal edges than vertical edges). Blurry Thresh is the threshold blurriness score set for delineating good images (less than Blurry Thresh) from bad images (greater than Blurry Thresh). CD Limit is a determined value of interest for the critical dimension. SEM1 and SEM2 are data sets acquired using two different scanning electron microscopes, designated SEM1 and SEM2. By using a suite of visualization charts such as shown in FIG. 7, or using a similar suite, various decisions can be made regarding the setting of limits and thresholds, whether to set different limits and thresholds for different imaging devices, whether and when to run further analysis on additional data, whether to recalibrate, and so forth.

Image quantification methodology in accordance with the present disclosure can provide significant improvements in scalability and coverage compared to previous custom model approaches. For example, methodologies of the present disclosure do not require custom development for each individual process or tool, allowing them to work on any image from any microscope or imaging tool. This flexibility enables rapid live deployment and easy maintenance across various production stages and processes.

Image quantification methodology in accordance with the present disclosure can significantly improve operational efficiency and contribute to cost reduction by reducing scrap, minimizing unnecessary cycle time, and cutting down on rework. This aids in optimizing production efficiency and improving imaging equipment efficiency, further streamlining manufacturing processes and driving substantial cost avoidance. By addressing the limitations of previous custom model approaches, image quantification methods of the present disclosure provide broader coverage and more efficient focus quality assessments. This can result in reducing the need for manual review of images and eliminating the extensive manual effort required to train custom models and evaluate images. This not only saves valuable time for engineers but also allows for more streamlined processes across the board, improving overall operational efficiency.

Image quantification methodology in accordance with the present disclosure can unlock the full potential of imaging data. The described image quantification methods more effectively transform raw data into actionable insights, enhancing decision-making and overall operational efficiency. In wafer factories, the output may be integrated into wafer processes, providing confidence in measurements and supporting composite AI and root cause analysis algorithms for improved wafer production.

The deployment of image quantification methodology in accordance with the present disclosure in shadow mode can reduce the need for manual input in model training and development. With an automated evaluation script in place, the system can quickly assess image quality with minimal human intervention, reducing manual effort and streamlining the entire process. Additionally, with the expanded coverage provided by the generalized solution, manual review of images is not required in determining focus quality. This means that image quality can be ruled out as a factor whenever there may be an issue with the process, ensuring faster identification of root causes and reducing the time spent on troubleshooting.

In accordance with image quantification methodology of the present disclosure, specifications set by engineers may be used to determine the good/bad quality of images in production inferencing. By utilizing historical data in shadow deployment, the visualizations of the correlation between CD and image quality are generated to help operators set an accurate threshold. This improves efficiency and overcomes many challenges such as variation in products, imbalance in quality of tools, and process changes. Information from the evaluation framework may also be helpful for engineers to detect any abnormality in the process and tool health.

Image quantification methodology of the present disclosure enables the integration of composite AI systems that can combine insights from multiple sources for even more powerful decision-making. The ability to leverage various AI solutions together enhances overall operational efficiency and supports the development of more sophisticated AI applications across factories. This paves the way for further AI-driven advancements, ultimately driving continuous improvements in manufacturing quality and process optimization.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A method for evaluating the quality of an image, the method comprising:
segmenting the image into a plurality of N patches;
preparing a plurality of L qualified patches based on at least a subset of the N patches;
for each patch of the L qualified patches, generating a quality score metric and an estimate of significance to an overall quality of the image; and
combining the quality score metrics for all of the L qualified patches in an importance-weighted fashion using the estimate of significance to thereby generate one or more composite focus quality scores for the image.

2. The method of claim 1, further comprising eliminating background noise from the image prior to segmenting the image into the plurality of N patches.

3. The method of claim 1, further comprising for each of the plurality of N patches, identifying whether at least one component feature is included.

4. The method of claim 3, wherein identifying whether at least one component feature is included comprises determining whether a number of pixels associated with the at least one component feature exceeds a threshold pixel amount.

5. The method of claim 3, further comprising selecting M candidate patches from the N patches, each of the M candidate patches including at least one connected component feature.

6. The method of claim 5, wherein preparing the L qualified patches comprises, for each of the connected component features included in a corresponding one of the M candidate patches, shifting the corresponding candidate patch to place the connected component feature at or near a center of the corresponding candidate patch, thereby creating a shifted candidate patch for each of the connected component features.

7. The method of claim 6, further comprising removing one or more of the shifted candidate patches that are determined to include connected component features duplicated in at least one other of the shifted candidate patches.

8. The method of claim 1, further comprising for each patch of the L qualified patches, identifying edges of any component features.

9. The method of claim 8, further comprising for each patch of the L qualified patches, creating a corresponding mask using the identified edges of any component features, and applying the corresponding mask prior to generate a region of interest for the image.

10. The method of claim 9, wherein for each patch of the L qualified patches, generating the quality score metrics comprises combining a maximum pixel value for the qualified patch, a minimum pixel value for the qualified patch, a mean pixel value for the qualified patch, and a mean pixel value for the image.

11. The method of claim 8, wherein the estimate of significance to overall quality of the image correlates to an amount of edges such that the estimate of significance is greater for patches that include more edges and the estimate of significance is less for patches that include fewer edges.

12. The method of claim 1, wherein the one or more composite focus quality scores include an average blurriness score, a vertical blurriness score, and a horizontal blurriness score.

13. The method of claim 1, wherein the recited segmenting, determining, generating, and combining are performed without the aid of manual review or trained machine learning models.

14. A system for evaluating the quality of generated images of specimens, the method comprising:
at least one imaging tool for acquiring images to be analyzed;
a data storage module to store images acquired by the at least one imaging tool; and
an image analysis module configured to perform the following for an image acquired by the at least one imaging tool:
segment the image into a plurality of N patches;
prepare a plurality of L qualified patches from at least a subset of the N patches;
for each patch of the L qualified patches, generate a quality score metric and an estimate of significance to overall quality of the image; and
combine the quality score metrics for all patches in an importance-weighted fashion using the estimate of significance to thereby generate one or more composite focus quality scores for the image.

15. The system of claim 14, further comprising a display module configured to display visualizations of composite focus quality scores produced by the image analysis module for a plurality of images generated by the at least one imaging tool.

16. The system of claim 15, wherein the visualizations of composite focus quality scores are configured to facilitate setting thresholds for defining good image quality and bad image quality.

17. The system of claim 16, wherein the visualizations of composite focus quality scores are configured to facilitate setting different thresholds of image quality for each imaging tool of the at least one imaging tool.

18. The system of claim 16, wherein the visualizations of composite focus quality scores are configured to facilitate setting different thresholds of image quality for different specimen types.

19. The system of claim 16, wherein the visualizations of composite focus quality scores are configured to facilitate determining whether a change has occurred with image acquisition processes.

20. The system of claim 14, wherein the at least one imaging tool includes a camera, a conventional microscope, a scanning electron microscope, a focus ion beam imager, and/or an electron-beam defect review imager.

21. The system of claim 14, wherein the image analysis module is further configured to save the composite focus quality score to a database configured for remote access.

22. The system of claim 14, wherein the system is integrated into a wafer production facility and the specimens are wafers.
